(19) United States
(12) Patent Application Publication
(10) Pub. No.: US 2026/0329152 A1
(43) Pub. Date: Oct. 22, 2026

(54) CAMERA WINDOW HOUSING ASSEMBLIES INCLUDING PASSIVE THERMAL STRESS BALANCING ELEMENTS

(71) Applicant: Raytheon Company, Arlington, VA (US)

(72) Inventors: Paul T. Fini, Santa Barbara, CA (US); Stephen Marinsek, Albuquerque, NM (US); Brendan E. O’Rorke, Santa Barbara, CA (US)

(21) Appl. No.: 19/182,967

(22) Filed: Apr. 18, 2025

(51) Int. Cl. G03B 17/02

(52) U.S. Cl. CPC G03B 17/02

(57) ABSTRACT

A camera window housing assembly includes a window housing, a window, and a balancing element. The window is coupled to the window housing and is configured to transmit energy received at the camera window housing assembly. The balancing element is configured to apply compressive stress to a window joint for the camera window housing assembly. In some cases, the window housing includes a first material having a first coefficient of thermal expansion (CTE), the balancing element includes a second material having a second CTE, and the first CTE is different from the second CTE.

### TECHNICAL FIELD

This disclosure is generally directed to dewar assemblies. More specifically, this disclosure is directed to camera window housing assemblies including passive thermal stress balancing elements.

### BACKGROUND

A dewar assembly with cryogenic cooling of a sensor chip often needs to maintain internal vacuum integrity over its intended service life, which may typically be up to 25 years or more. A window-to-housing joint is a high-risk area for leaks, both instantaneous and latent. Due to the often extremely wide dewar assembly operational temperature range, voids, cracks, or peeling can occur in the joint, resulting in a leak path and shortened operational lifetime. This risk is currently mitigated by using alloys having controlled coefficients of thermal expansion to form a housing. However, these alloys are expensive, difficult to source, and have long and/or unpredictable lead times. In addition, these issues are becoming increasingly problematic as the sizes of sensor chips (and, therefore, dewar housings) are trending larger.

### SUMMARY

This disclosure relates to camera window housing assemblies including passive thermal stress balancing elements.

In a first embodiment, a camera window housing assembly may include a window housing, a window, and a balancing element. The window may be coupled to the window housing and may be configured to transmit energy received at the camera window housing assembly. The balancing element may be configured to apply compressive stress to a window joint for the camera window housing assembly.

Any single one or any combination of the following features may be used with the first embodiment. The balancing element may be coupled to the window housing using one of a braze, solder, adhesive, a weld, or a slip/interference fit. The balancing element may be coupled to an exterior of the window housing. The window joint may include a joint between the window and the window housing. The window housing may include a recess, and a lower surface of the window may be coupled to an upper surface of the recess of the window housing by a joining material. The window joint may include a joint between the joining material and the window housing. The balancing element may be coupled between the window and the window housing. The window joint may include a joint between the window and the balancing element. The window housing may be configured to apply compressive stress to the balancing element. The window housing may include a flare configured to balance the compressive stress applied to the balancing element. The window housing may include a first material having a first coefficient of thermal expansion (CTE), the balancing element may include a second material having a second CTE, and the first CTE may be different from the second CTE. The window housing may include one of 304/316 Stainless, Aluminum 6061, Aluminum 7075, Grade 5 Titanium (Ti-6Al-4V), INCONEL® Alloy 600, Alloy 42, or Kovar®. The balancing element may include one of Alloy 42, Kovar®, Invar 36, ALLVAR Alloy 30, a titanium-zirconium-molybdenum alloy, or an aluminum alloy.

In a second embodiment, a camera may include a window housing assembly and a sensor chip assembly. The window housing assembly may include a window housing, a window, and a balancing element. The window may be coupled to the window housing and configured to transmit energy received at the camera. The balancing element may be configured to apply compressive stress to a window joint for the window housing assembly. The sensor chip assembly may be configured to detect the energy transmitted by the window.

Any single one or any combination of the following features may be used with the second embodiment. The balancing element may be coupled to the window housing using one of a braze, solder, adhesive, a weld, or a slip/interference fit. The balancing element may be coupled to an exterior of the window housing. The window joint may include a joint between the window and the window housing. The window housing may include a recess, and a lower surface of the window may be coupled to an upper surface of the recess of the window housing by a joining material. The window joint may include a joint between the joining material and the window housing. The balancing element may be coupled between the window and the window housing. The window joint may include a joint between the window and the balancing element. The window housing may be configured to apply compressive stress to the balancing element. The window housing may include a flare configured to balance the compressive stress applied to the balancing element. The window housing may include a first material having a first CTE, the balancing element may include a second material having a second CTE, and the first CTE may be different from the second CTE. The window housing may include one of 304/316 Stainless, Aluminum 6061, Aluminum 7075, Grade 5 Titanium (Ti-6Al-4V), INCONEL® Alloy 600, Alloy 42, or Kovar®. The balancing element may include one of Alloy 42, Kovar®, Invar 36, ALLVAR Alloy 30, a titanium-zirconium-molybdenum alloy, or an aluminum alloy. The energy transmitted by the window and detected by the sensor chip assembly may include at least one of infrared, visible light, or ultraviolet light.

In a third embodiment, a camera window housing assembly may include a window housing, a window, and a balancing element. The window housing may include a first material having a first CTE. The window may be coupled to the window housing at a window joint. The window may be configured to transmit a specified range of wavelengths of light received at the camera window housing assembly. The balancing element may be coupled around an exterior of the window housing. The balancing element may include a second material having a second CTE that is different from the first CTE and may be configured to provide passive thermal stress balancing at the window joint.

The following feature may be used with the third embodiment. The balancing element may be coupled around the exterior of the window housing using one of a braze, solder, adhesive, a weld, or a slip/interference fit.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1A illustrates an example of a camera according to this disclosure;

FIGS. 1B and 1C illustrate examples of an interior portion and an exterior portion, respectively, of the window housing assembly of FIG. 1A according to this disclosure;

FIG. 1D illustrates an example of a portion of the window housing assembly of FIGS. 1B and 1C according to this disclosure;

FIG. 1E illustrates another example of a portion of the window housing assembly of FIGS. 1B and 1C according to this disclosure;

FIG. 2A illustrates an example of a portion of an alternative window housing assembly according to this disclosure; and

FIG. 2B illustrates another example of a portion of an alternative window housing assembly according to this disclosure.

### DETAILED DESCRIPTION

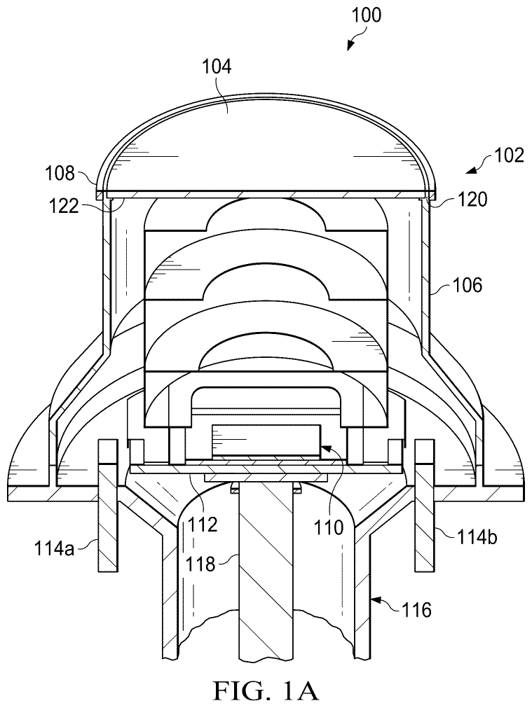

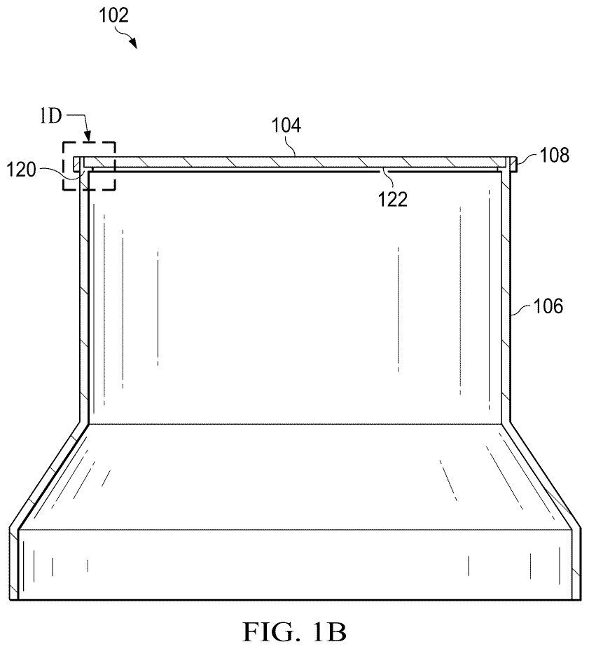

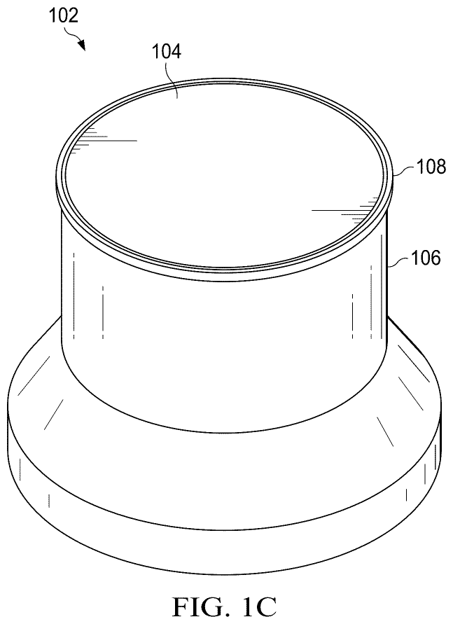

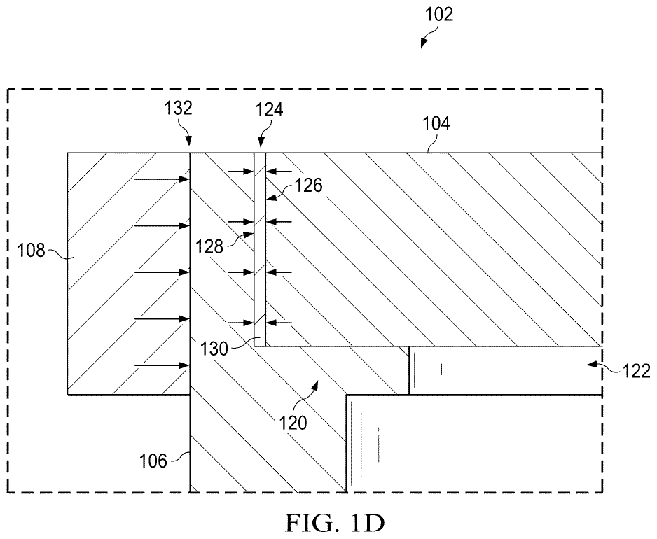

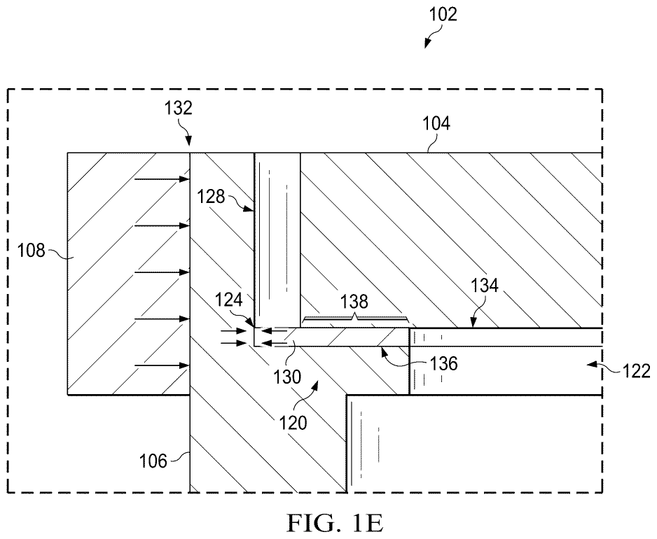

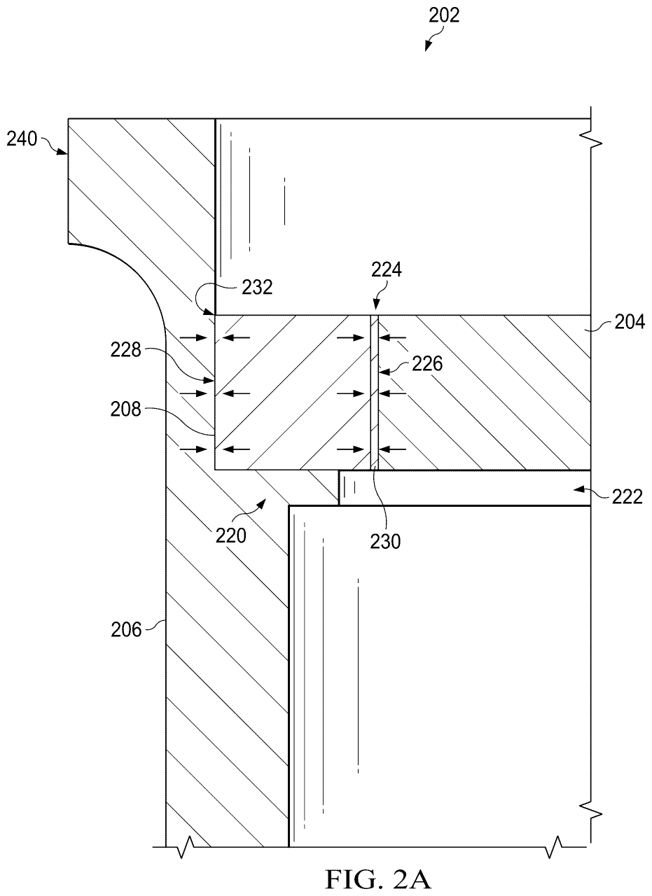

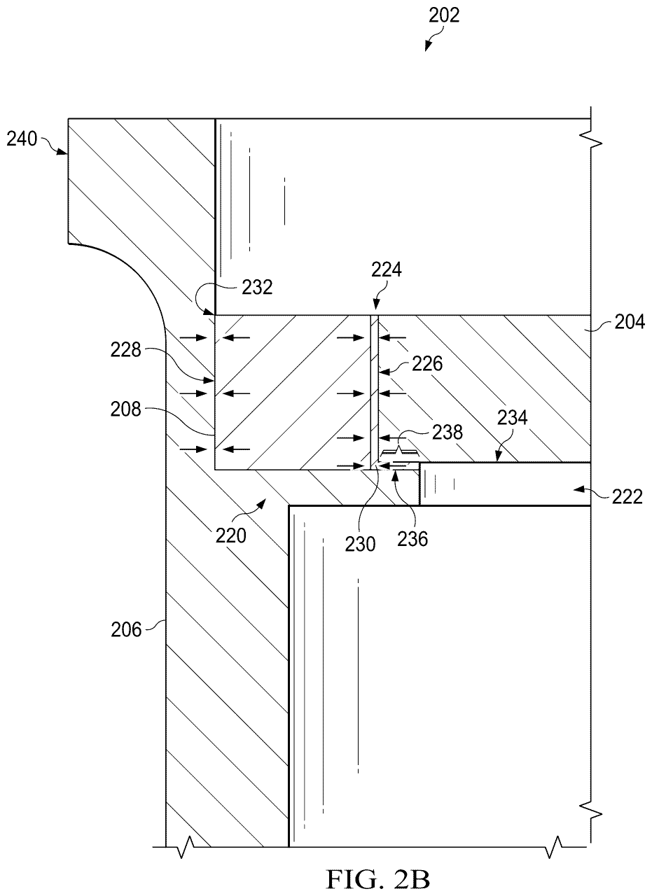

FIGS. 1A through 2B, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, a dewar assembly with cryogenic cooling of a sensor chip often needs to maintain internal vacuum integrity over its intended service life, which may typically be up to 25 years or more. A window-to-housing joint is a high-risk area for leaks, both instantaneous and latent. Due to the often extremely wide dewar assembly operational temperature range (for example, −55 °C to +85 °C in some applications), voids, cracks, or peeling can occur in the joint, resulting in a leak path and shortened operational lifetime. This risk is currently mitigated by using alloys having controlled coefficients of thermal expansion to form a housing. However, these alloys are expensive, difficult to source, and have long and/or unpredictable lead times. In addition, these issues are becoming increasingly problematic as the sizes of housings are trending larger due to increasing sensor chip size.

This disclosure provides various economical camera window housing assemblies that include elements to provide passive thermal stress balancing. As described in more detail below, each of the window housing assemblies can include a window housing, a window, and a balancing element. The window can be coupled to the window housing and can be configured to transmit energy received at the camera window housing assembly. The balancing element can be configured to provide compressive stress on a joint for the camera window housing assembly. The described window housing assemblies can provide a net thermal contraction around the window, keeping each assembly's joint in a gentle compression and thereby reducing residual stress at the joint. In this way, the operational lifetime of a camera can be increased, while less expensive and more readily available materials can be used to form the window housing assemblies.

FIG. 1A illustrates an example of a camera 100 according to this disclosure. More specifically, FIG. 1A illustrates a longitudinal cross-sectional view of the camera 100. The embodiment of the camera 100 shown in FIG. 1A is for illustration only. Other embodiments of the camera 100 may be used without departing from the scope of this disclosure.

According to embodiments of this disclosure, the camera 100 includes a window housing assembly 102, which includes a window 104, a window housing 106, and a balancing element 108. The camera 100 can also include a sensor chip assembly 110, a platform 112, feed-through connectors 114-114b, and a lower housing assembly 116, which can include a cold finger 118.

The window housing assembly 102 and the lower housing assembly 116 can be coupled together to form a housing assembly for the camera 100. The housing assembly can be designed to maintain hermeticity (remain hermetically sealed) over any suitable operational lifetime, such as 15 years, 25 years, 35 years, or other suitable time period. FIGS. 1B and 1C illustrate examples of an interior view and an exterior view, respectively, of the window housing assembly 102 according to this disclosure, and FIGS. 1D and 1E illustrate examples of a portion of the window housing assembly 102 according to this disclosure.

The window 104 can include glass, ceramic, a semiconductor material, or any other suitable material(s) transparent to a specified range of wavelengths that can be sensed by the sensor chip assembly 110. This wavelength range can include infrared, visible light, ultraviolet light, and/or any other suitable type(s) of electromagnetic wavelengths. In some embodiments, the window 104 can include germanium, silicon, zinc sulfide, fused silica, borosilicate glass, BK7 glass, sapphire, calcium fluoride, or the like. Also, in some embodiments, the window 104 can include an anti-reflective coating to enhance light transmission for the wavelength range of interest.

The window housing 106 can include any suitable metal, alloy, or other material(s). In some embodiments, the window housing 106 can include 304/316 Stainless, Aluminum 6061 or 7075, Grade 5 Titanium (Ti-6Al-4V), INCONEL® Alloy 600, Alloy 42, Kovar®, or other suitable metallic material(s). The top side of the window housing 106 may include a recess 120 that fits the window 104, such as when dimensions and contours of the recess 120 correspond to the thickness and exterior surfaces of the window 104. The top side of the window housing 106 may include an opening 122 adjacent to the recess 120. In some cases, the opening 122 may be concentric with the recess 120 and may have a diameter that is less than the diameter of the window 104.

The balancing element 108 can be configured to provide passive thermal stress balancing for the window housing assembly 102. In the embodiment illustrated in FIGS. 1A through 1E, the balancing element 108 can be coupled to an exterior of the window housing 106. In these embodiments, the balancing element 108 can be positioned along an outer surface of the window housing 106 across from where the window 104 is coupled to an inner surface of the window housing 106. Thus, the balancing element 108 can be substantially aligned with the window 104. In addition, for the illustrated embodiments, the balancing element 108 can include a circular, ring shape. However, the balancing element 108 can include any suitable shape based on the shapes of the window 104 and the window housing 106.

The balancing element 108 can include any suitable metal, alloy, or other material(s). In some cases, the balancing element 108 can include Alloy 42, Kovar®, Invar 36, ALLVAR Alloy 30, a titanium-zirconium-molybdenum alloy, an aluminum alloy, such as 6061-T6 or the like, or other suitable metallic material(s). In some embodiments, the material(s) for the balancing element 108 can be chosen to have a lower coefficient of thermal expansion (CTE) than the CTE of the material(s) for the window housing 106. As described in more detail below, the balancing element 108 can be configured to apply a compressive force around the window housing 106 where the window 104 is installed such that an interface between the window 104 and the window housing 106 is subjected to mild compressive stress as opposed to tensile stress over most, if not all, of the intended operating temperature range.

The sensor chip assembly 110 can be positioned on the platform 112 and can be configured to detect energy that enters through the window 104 and generate a corresponding electric signal, which can be carried through the feed-through connectors 114a-114b for processing. As described above, the sensor chip assembly 110 can be configured to detect energy within at least a specified range of wavelengths of light. In some embodiments, the platform 112 can include a ceramic platform or a platform formed of other suitable material(s). Also, in some embodiments, the feed-through connectors 114a-114b can include ceramic connectors or connectors formed of other suitable material(s), and the feed-through connectors 114a-114b can have a lateral cross-section that is rectangular or other suitable shape.

The cold finger 118 can include a bore extending longitudinally. In some cases, the cold finger 118 can have the shape of a hollow cylinder. A localized cold surface can be generated at an upper end of the cold finger 118 to remove heat from the sensor chip assembly 110. In some embodiments, the cold finger 118 can include a cryocooler with a displacer configured to move back and forth rapidly or a cryostat that can use a gas, such as nitrogen, argon, or the like, to cool the sensor chip assembly 110. In some cases, the cold finger 118 can be configured to cool the sensor chip assembly 110 to around 80 K. In other cases, the cold finger 118 can be configured to cool the sensor chip assembly 110 to around 10 K, 20 K, or other suitable temperature(s).

As illustrated in FIG. 1D, in some embodiments, the window housing assembly 102 can include a window joint 124 at an interface between a periphery 126 of the window 104 and an inner surface 128 of the window housing 106. The window 104 and the window housing 106 can be coupled together at the window joint 124 using a joining material 130, such as solder, braze alloy, epoxy, silicone, or any other suitable joining material(s). In some cases, the periphery 126 of the window 104 can be metallized before the window 104 is coupled to the window housing 106. In particular embodiments, the window 104 can be metallized using copper, nickel, chromium, or other suitable metal(s).

After soldering or other joining method and/or during exposure to the operating temperature range, tensile stress in the window joint 124 would tend to pull the window 104 and the window housing 106 apart from each other. However, by including the balancing element 108 as part of the window housing assembly 102, tensile stress is avoided. Instead, a mild compressive stress can be created, which tends to push the window 104 and the window housing 106 toward each other. This compressive stress is provided at the window joint 124 as indicated by the arrows along the window joint 124 in FIG. 1D.

Using high-fidelity stress modeling and validated property inputs, the composition and geometry of the balancing element 108 can be tailored to achieve a substantially uniform net compressive force on the window joint 124 over the entire operational temperature range for the camera 100. For example, the composition of the balancing element 108 can be chosen at least in part based on the CTE for the material(s) of the balancing element 108 such that the CTE is different from the CTE for the material(s) of the window housing 106. In this way, the balancing element 108 can be designed such that the stress on the window joint 124 remains mildly compressive across the temperature range, where “mildly compressive” means a relatively low (near-zero) stress that is net compressive as compared to tensile.

The window housing assembly 102 can include an external interface 132 between the window housing 106 and the balancing element 108. The balancing element 108 can be configured to apply compressive stress at the external interface 132 as indicated by the arrows along the external interface 132 in FIG. 1D. The window housing 106 and the balancing element 108 can be coupled together at the external interface 132 using a braze, solder, welding, adhesive, slip/interference fit, or any other suitable metal-to-metal or other joining method such that there is intimate and substantially uniform contact along the external interface 132. The window housing 106 and the balancing element 108 can be coupled together using any of these methods, such as along substantially the entire external interface 132 or at upper and lower edges of the external interface 132.

In some embodiments, the window housing 106 and the balancing element 108 can be coupled together at an elevated temperature. As a particular example, in embodiments in which the window housing 106 and the balancing element 108 are coupled together using a slip/interference fit, the coupling may be provided at an elevated temperature such that an interference fit results at ambient temperatures. In some embodiments in which the window housing 106 and the balancing element 108 are coupled together using solder, the solder can be chosen such that a melting temperature of the solder is greater than a melting temperature of the joining material 130 used to join the window 104 and the window housing 106 at the window joint 124. Similarly, in some embodiments in which the window housing 106 and the balancing element 108 are coupled together using a braze, the braze can be chosen such that a melting temperature of the braze alloy is much greater than a melting temperature of the joining material 130 used to join the window 104 and the window housing 106 at the window joint 124.

FIG. 1E illustrates another example of a portion of the window housing assembly 102 according to this disclosure. The embodiment illustrated in FIG. 1E could be used as an alternative to the embodiment illustrated in FIG. 1D. In the embodiment illustrated in FIG. 1E, the window 104 and the window housing 106 can be coupled together at an interface between a lower surface 134 of the window 104 and an upper surface 136 of the recess 120 portion of the window housing 106. The window 104 and the window housing 106 can be coupled together using the joining material 130. In some cases, a portion of the lower surface 134 of the window 104 can be metallized to create a metallized area 138 on the window 104 for coupling the window 104 to the window housing 106. Also, in some cases, the metallized area 138 can include a layer of metal around at least an outer perimeter portion of the lower surface 134 of the window 104. The metallized area 138 can include copper, nickel, chromium, or other suitable metal(s). In these embodiments, the window joint 124 can be positioned between the inner surface 128 of the window housing 106 and the joining material 130 that couples the window 104 to the window housing 106 as indicated by the arrows at the window joint 124 in FIG. 1E.

Using the embodiment illustrated in either FIG. 1D or 1E, a composite window housing assembly 102 can be provided that uses two or more materials with dissimilar CTEs (with one CTE for the window housing 106 and a different CTE for the balancing element 108) to result in a balanced and compressive force on the window joint 124. As a result, even with a relatively large window housing 106 in which stress on the window joint 124 could be greatly increased as compared to stress on a window joint for a smaller window housing, the camera 100 can be configured to prevent voids, cracks, or peeling in the window joint 124 due to tensile stress, thereby increasing operational lifetime of the camera 100. In addition, in some cases, the window housing assembly 102 can be implemented at a greatly reduced cost as compared to a conventional window housing assembly due to the option of using more cost-effective and more readily-available materials for the window housing 106.

The camera 100 including the window housing assembly 102 may find use in a large number of applications due to its economic advantage over conventional housing designs. For example, the camera 100 may be included in systems requiring cryogenically cooled infrared detectors. As a particular example, the camera 100 may be used as a thermal camera for long-range surveillance. As another particular example, the camera 100 may be used in applications involving low-visibility conditions, like fog or darkness. As yet another particular example, the camera 100 may be used for providing high-resolution imagery in platforms like micro-satellites and unmanned aerial vehicles (UAVs). The camera 100 may also be included in space instruments for planetary science. As a particular example, the camera 100 can be used for imaging provided by a rocket, where the harsh conditions of space could otherwise affect imaging performance. As another particular example, the camera 100 can be used for imaging in low-temperature physics experiments or materials testing. The camera 100 may also be used for medical applications, including mapping body temperatures for providing non-invasive diagnostic testing. Note, however, that this disclosure is not limited to any particular application of the camera 100.

Although FIG. 1A illustrates one example of a camera 100, FIGS. 1B and 1C illustrate one example of the window housing assembly 102 of the camera 100, and FIGS. 1D and 1E illustrate examples of a portion of the window housing assembly 102, various changes may be made to FIGS. 1A through 1E. For example, the camera 100 may include additional components not illustrated in or described with respect to FIG. 1A. Also, the joining material 130 of FIGS. 1D and 1E could be combined such that the window 104 could be joined to the window housing 106 at both the periphery 126 of the window 104 and the lower surface 134 of the window 104. In some embodiments such as this, the metallization at the periphery 126 and at the lower surface 134 may contact each other to create a continuous surface for joining the window 104 to the window housing 106. In addition, the views shown in FIGS. 1A through 1E are not to scale.

FIG. 2A illustrates an example of a portion of an alternative window housing assembly 202 according to this disclosure. The embodiment of the window housing assembly 202 shown in FIG. 2A is for illustration only. Other embodiments of the window housing assembly 202 may be used without departing from the scope of this disclosure.

According to embodiments of this disclosure, the window housing assembly 202 includes a window 204, a window housing 206, and a balancing element 208. The window housing assembly 202 illustrated in FIG. 2A can be used in the camera 100 in place of the window housing assembly 102 of FIGS. 1A through 1E. The window housing assembly 202 can be implemented in some cases in which the CTE for the material(s) of the window housing 206 is greater than the CTE for the material(s) of the window 204. Also, in these embodiments, the balancing element 208 can have a relatively low CTE as compared to the CTE of the window housing 206.

In the embodiment illustrated in FIG. 2A, the balancing element 208 can be coupled between the window 204 and the window housing 206. Thus, the balancing element 208 can be positioned between a periphery 226 of the window 204 and an inner surface 228 of the window housing 206. The window 204 and the balancing element 208 can be coupled together at a window joint 224 using a joining material 230, such as solder, braze alloy, epoxy, silicone, or any other suitable joining material(s). In some cases, the periphery 226 of the window 204 can be metallized before the window 204 is coupled to the balancing element 208. In particular embodiments, the window 204 can be metallized using copper, nickel, chromium, or other suitable metal(s).

In these embodiments, the balancing element 208 can be configured to apply an inwardly pushing force around the window 204 such that the window joint 224 between the window 204 and the balancing element 208 is subjected to a mild net compressive stress, as opposed to tensile stress. As a result, stress at the window joint 224 is reduced, preventing optic fracture of the window 204 from high or unbalanced stresses.

In some embodiments, the top side of the window housing 206 may include a recess 220 that fits the balancing element 208 (instead of the window 204), such as when dimensions and contours of the recess 220 correspond to the thickness and exterior surfaces of the balancing element 208. The top side of the window housing 206 may include an opening 222 adjacent to the recess 220. In some cases, the opening 222 may be concentric with the recess 220 and may have a diameter that is less than the diameter of the balancing element 208.

In some embodiments, the window housing 206 may be configured to apply compressive stress to the balancing element 208, while the balancing element 208 pushes back on the window housing 206 as indicated by the arrows along the external interface 232 in FIG. 2A. In this configuration, the stress distribution can potentially be uneven. Because of this, the design of the window housing 206 can include a flare 240 or analogous feature to balance the compressive stress applied to the balancing element 208 from the window housing 206. Thus, including the flare 240 as part of the design of the window housing 206 can compensate for undue stress in the window housing 206.

In the embodiment illustrated in FIG. 2B, the structure of the window housing assembly 202 is similar to the structure of the window housing assembly 202 of FIG. 2A. However, in the embodiment of FIG. 2B, the window 204 can be coupled to the window housing 206 at a lower surface 234 of the window 204 in addition to being coupled to the balancing element 208 at the periphery 226 of the window 204. Thus, in these embodiments, the opening 222 may be concentric with the recess 220 and may have a diameter that is less than the diameter of the window 204 (instead of the balancing element 208).

In the illustrated embodiment, the window 204 and the window housing 206 can be coupled together at an interface between the lower surface 234 of the window 104 and an upper surface 236 of the recess 220 portion of the window housing 206. The window 204 and the window housing 206 can be coupled together using the joining material 230 that couples the window 204 to the balancing element 208. In some cases, a portion of the lower surface 234 of the window 204 can be metallized to create a metallized area 238 on the window 204 for coupling the window 204 to the window housing 206. Also, in some cases, the metallized area 238 can include a layer of metal around at least an outer perimeter portion of the lower surface 234 of the window 204. The metallized area 238 can include copper, nickel, chromium, or other suitable metal(s).

In some embodiments, in addition to being positioned between the window 204 and the balancing element 208, the window joint 224 can also continue beneath the window 204 between the balancing element 208 and the joining material 230 that couples the window 204 to the window housing 206 as indicated by the arrows in FIG. 2B. In addition, in some embodiments, the metallization at the periphery 226 and at the lower surface 234 can contact each other to create a continuous surface for joining the window 204 to both the balancing element 208 and the window housing 206.

Although FIGS. 2A and 2B illustrate examples of portions of an alternative window housing assembly 202, various changes may be made to FIGS. 2A and 2B. For example, the embodiment illustrated in FIG. 2A includes no support underneath the window 204 provided by the window housing 206. However, the embodiment of FIG. 2A could be implemented with the recess 220 of the window housing 206 extending underneath the window 204 to provide support underneath the window 204 by the window housing 206. In addition, the views shown in FIGS. 2A and 2B are not to scale.

It may be advantageous to set forth definitions of certain words and phrases used throughout this patent document. The term “about” (when used with a numerical value) indicates that the numerical value may vary by up to ±10%. The terms “include” and “include,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. §110(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §110(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A camera window housing assembly comprising:
a window housing;
a window coupled to the window housing, the window configured to transmit energy received at the camera window housing assembly; and
a balancing element configured to apply compressive stress to a window joint for the camera window housing assembly.

2. The camera window housing assembly of claim 1, wherein the balancing element is coupled to the window housing using one of a braze, solder, adhesive, a weld, or a slip/interference fit.

3. The camera window housing assembly of claim 1, wherein:
the balancing element is coupled to an exterior of the window housing; and
the window joint comprises a joint between the window and the window housing.

4. The camera window housing assembly of claim 1, wherein:
the balancing element is coupled to an exterior of the window housing;
the window housing comprises a recess;
a lower surface of the window is coupled to an upper surface of the recess of the window housing by a joining material; and
the window joint comprises a joint between the joining material and the window housing.

5. The camera window housing assembly of claim 1, wherein:
the balancing element is coupled between the window and the window housing;
the window joint comprises a joint between the window and the balancing element;
the window housing is configured to apply compressive stress to the balancing element; and
the window housing comprises a flare configured to balance the compressive stress applied to the balancing element.

6. The camera window housing assembly of claim 5, wherein:
the window housing comprises a recess; and
a lower surface of the window is coupled to an upper surface of the recess of the window housing.

7. The camera window housing assembly of claim 1, wherein:
the window housing comprises a first material having a first coefficient of thermal expansion (CTE);
the balancing element comprises a second material having a second CTE; and
the first CTE is different from the second CTE.

8. The camera window housing assembly of claim 1, wherein the window housing comprises one of 304/316 Stainless, Aluminum 6061, Aluminum 7075, Grade 5 Titanium (Ti-6Al-4V), INCONEL® Alloy 600, Alloy 42, or Kovar®.

9. The camera window housing assembly of claim 1, wherein the balancing element comprises one of Alloy 42, Kovar®, Invar 36, ALLVAR Alloy 30, a titanium-zirconium-molybdenum alloy, or an aluminum alloy.

10. A camera comprising:
a window housing assembly comprising:
a window housing;
a window coupled to the window housing, the window configured to transmit energy received at the camera, and
a balancing element configured to apply compressive stress to a window joint for the window housing assembly; and
a sensor chip assembly configured to detect the energy transmitted by the window.

11. The camera of claim 10, wherein the balancing element is coupled to the window housing using one of a braze, solder, adhesive, a weld, or a slip/interference fit.

12. The camera of claim 10, wherein:
the balancing element is coupled to an exterior of the window housing; and
the window joint comprises a joint between the window and the window housing.

13. The camera of claim 10, wherein:
the balancing element is coupled to an exterior of the window housing;
the window housing comprises a recess;
a lower surface of the window is coupled to an upper surface of the recess of the window housing by a joining material; and
the window joint comprises a joint between the joining material and the window housing.

14. The camera of claim 10, wherein:
the balancing element is coupled between the window and the window housing;
the window joint comprises a joint between the window and the balancing element;
the window housing is configured to apply compressive stress to the balancing element; and
the window housing comprises a flare configured to balance the compressive stress applied to the balancing element.

15. The camera of claim 14, wherein:
the window housing comprises a recess; and
a lower surface of the window is coupled to an upper surface of the recess of the window housing.

16. The camera of claim 10, wherein:
the window housing comprises a first material having a first coefficient of thermal expansion (CTE);
the balancing element comprises a second material having a second CTE; and
the first CTE is different from the second CTE.

17. The camera of claim 10, wherein:
the window housing comprises one of 304/316 Stainless, Aluminum 6061, Aluminum 7075, Grade 5 Titanium (Ti-6Al-4V), INCONEL® Alloy 600, Alloy 42, or Kovar®; and
the balancing element comprises one of Alloy 42, Kovar®, Invar 36, ALLVAR Alloy 30, a titanium-zirconium-molybdenum alloy, or an aluminum alloy.

18. The camera of claim 10, wherein the energy transmitted by the window and detected by the sensor chip assembly comprises at least one of infrared, visible light, or ultraviolet light.

19. A camera window housing assembly comprising:
a window housing comprising a first material having a first coefficient of thermal expansion (CTE);
a window coupled to the window housing at a window joint, the window configured to transmit a specified range of wavelengths of light received at the camera window housing assembly; and
a balancing element coupled around an exterior of the window housing, wherein the balancing element comprises a second material having a second CTE different from the first CTE, and wherein the balancing element is configured to provide passive thermal stress balancing at the window joint.

20. The camera window housing assembly of claim 19, wherein the balancing element is coupled around the exterior of the window housing using one of a braze, solder, adhesive, a weld, or a slip/interference fit.
